(19) United States
(12) Patent Application Publication
(10) Pub. No.: US 2024/0224866 A1
(43) Pub. Date: Jul. 11, 2024

(54) Fruit Picking Robot and End Effector Therefore

(71) Applicant: ABB Schweiz AG, Baden (CH)

(72) Inventor: Haayo Terpstra, Apeldoorn (NL)

(73) Assignee: ABB Schweiz AG, Baden (CH)

(21) Appl. No.: 18/610,791

(22) Filed: Mar. 20, 2024

Related U.S. Application Data
(63) Continuation of application No. PCT/EP2021/076397, filed on Sep. 24, 2021.

(51) Int. Cl. A01D 46/30; A01D 46/22; B25J 11/00; B25J 19/02

(52) U.S. Cl. CPC A01D 46/30; A01D 46/22; B25J 11/0045; B25J 19/02

(57) ABSTRACT

An end effector for a fruit picking robot has a distal portion comprising tools for seizing and detaching a fruit from its mother plant, a proximal portion comprising an interface for mounting the end effector to a robot arm, and a storage bay for picked fruit. The storage bay is elongate in a longitudinal direction and has a discharge port extending along the full length of the storage bay in the longitudinal direction. A fruit support member has a longitudinally extending edge which delimits the discharge port.

### CROSS-REFERENCE TO RELATED APPLICATIONS

The instant application claims priority to International Patent Application No. PCT/EP2021/076397, filed Sep. 24, 2021, which is incorporated herein in its entirety by reference.

FIELD OF THE DISCLOSURE

The present disclosure relates to a fruit-picking robot and to an end effector for such a robot.

### BACKGROUND OF THE INVENTION

A common problem of end effectors for fruit-picking robots is that a certain amount force must be applied to a fruit, or a stalk must be cut in order to detach the fruit from its mother plant, but the fruit and the plant shouldn't be injured in the process. Since fruits on a same plant vary in size, the end effector must adapt to such variations. The principle of operation of such end effectors can vary widely; an end effector can have fingers in different numbers for gripping a fruit by friction or by flexing around it, there can be a tool for cutting a stalk by which the fruit is connected to its mother plant, there can be a suction tool for seizing the fruit etc. What these tools have in common, though, is that once a fruit has been successfully detached from its mother plant, the end effector must move to a collecting box in order to dispose of the fruit before it can return to the plant and pick another fruit.

WO 2018/057562 A1 discloses a fruit picking robot whose end effector comprises a tube with a suction port for picking fruit is formed at one end, a vacuum source is connected to a central region of the tube, so that a fruit picked by the suction port will move through the tube, passing by the central portion, to an opposite end of the tube. When a fruit has reached said opposite end, a first flap descends into the tube, so as to cut the opposite end off from the vacuum, so that when a second flap opens, the fruit falls out. No measures are taken to limit the length of fall, so there is a high risk of the fruit being damaged in the fall.

Picking a second fruit before the first one is discharged is not practical, since the second fruit would block the first flap and thus prevent proper operation of the device.

### BRIEF SUMMARY OF THE INVENTION

In a general aspect, the present disclosure describes a fruit-picking robot and end effector which is highly efficient while minimizing the risk of damage to the fruit. According to a first aspect, the disclosure describes an end effector for a fruit picking robot having a distal portion comprising tools for seizing and detaching a fruit from its mother plant, a proximal portion comprising an interface for mounting the end effector to a robot arm, and a storage bay for picked fruit, which is elongate in a longitudinal direction, and which bay has a discharge port extending along the full length of the storage bay in the longitudinal direction and a fruit support member having a longitudinally extending edge which delimits the discharge port. The elongate shape allows to accommodate more than one fruit at a time in the storage bay, so that the end effector doesn't have to move from the plant to a collecting box and back whenever a fruit has been picked. By having the fruit in the storage bay pass across the longitudinally extending edge of the support member and through the discharge port, all fruit can be discharged under similar conditions, without picked fruit bumping into each other in the process. By placing the edge horizontally and close to a surface on which the fruit is to be discharged, a dropping distance can be made small or zero for each fruit in the storage bay.

### BRIEF DESCRIPTION OF THE SEVERAL VIEWS OF THE DRAWING(S)

FIG. 1 is a schematic view of a fruit picking robot during operation in accordance with the disclosure.

FIG. 2 is a schematic cross section of an end effector of the robot of FIG. 1.

FIG. 3 illustrates proximal and intermediate portions of the end effector of FIG. 1, seen from below.

FIG. 4 is a schematic section of the end effector of FIG. 1 along a longitudinal axis thereof, while picking a fruit.

FIG. 5 is schematic section of the end effector of FIG. 1 along a longitudinal axis thereof, while preparing to discharge picked fruit into a collecting box.

FIG. 6 is a cross section, analogous to FIG. 2, of an end effector according to a second embodiment of the disclosure.

FIG. 7 is a third, simplified embodiment of an end effector in accordance with the disclosure.

### DETAILED DESCRIPTION OF THE INVENTION

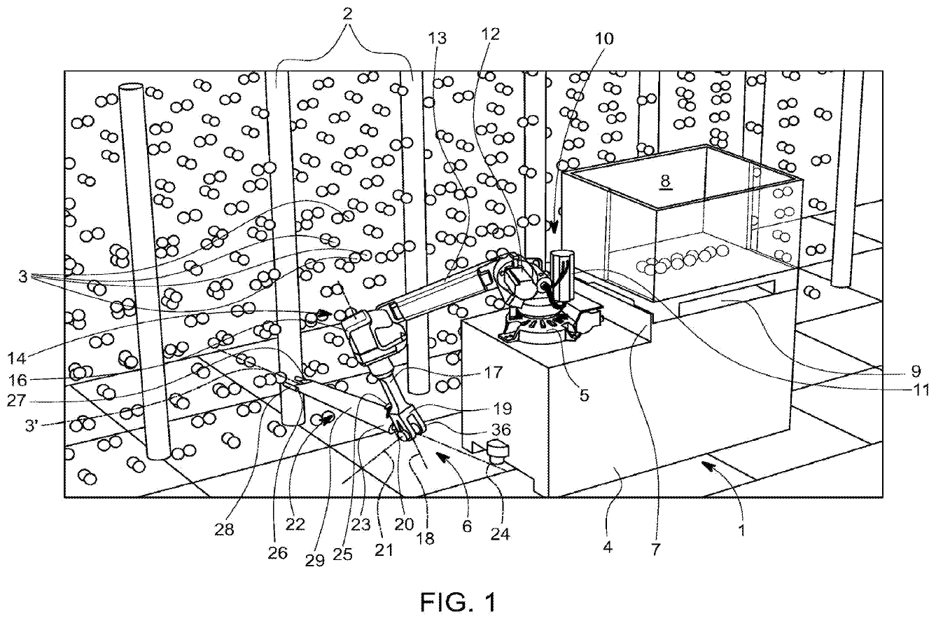

FIG. 1 is a schematic view of the robot 1 of the present invention diagram in front of a row of trees 2 bearing fruit 3 to be picked. The robot 1 comprises a cart 4, preferably an AGV, which is sized and designed to be autonomously movable in a corridor between rows of trees planted in parallel, as usual in commercial orchards. The cart 4 can have wheels or a crawler track, not shown.

On a top side of the cart 4 there is a basis 5 of an articulated arm 6, and, adjacent to the base, a support 7 for a box in which to collect the fruit. Typically, the support 7 is shaped for locking engagement with a conventional pallet box 8 of EUR 1 or EUR 2 type, i.e. having a length of 1.2 m and a width of 0.8 m or 1 .0 m, respectively. A width of 0.8 m of the box 8 is preferred, since it is easier to move between the rows of trees in an orchard than a 1.0 m wide box. The width of the cart 4 is the same as that of the box 8. The profile of the support 7 is such that horizontal channels 9 at the bottom of the pallet box 8 will remain open when the pallet box 7 is placed on the support, so that a forklift can be used for placing the pallet box 8 on the support 7 and for removing it from there when full. The cart 4 maybe provided with an integrated lift for loading and unloading the boxes 8.

While in FIG. 1 the support 7 is located substantially at the same height as basis 5, it can certainly also be located at a lower level, thus making it easier for the robot arm 6 to reach into the box 8 when discharging picked fruit.

The articulated arm 6 comprises a proximal motor member 10, rotatably connected to basis 5 by a vertical axis, and comprising a first motor 11 for driving this rotation. A second motor 12 is provided in member 10 to drive rotation of a proximal link 13 by a horizontal axis. An intermediate motor member 14 comprising two more motors 15, 16 is mounted to the distal end of link 13. One of these motors, 16, drives rotation of a distal link 17 by a longitudinal axis 18 thereof. At a distal end of link 17, a joint 36 and a fifth motor 19 are provided for rotating an adapter 20 by an axis 21 perpendicular to axis 18. The adapter 20 has a proximal portion 23 of an end effector 22 mounted to it.

The end effector 22 has a generally tubular or frusto-conical shape, the proximal portion 23 forming the wider base of a truncated cone whose axis defines a longitudinal axis 24 of the end effector 22. In a plane perpendicular to longitudinal axis 24 the end effector has an elongate cross section. A sixth motor, not shown, is provided in the adapter 20 for rotating the end effector 22 by the longitudinal axis 24, so that in any pose the arm 6 can adopt, a longer one of the two dimensions of the cross section will always extend horizontally. Thus, a fruit finding sensor 25, typically a camera, will be located on top of the distal portion 23 in any pose of the arm 6. The sensor 25 has a line of sight which is parallel to the longitudinal axis 24. It provides images of what lies on and around the axis 24 to a controller, not shown, thus enabling the controller to identify fruit to be picked, choose one, 3′, and aim the end effector 22 at it.

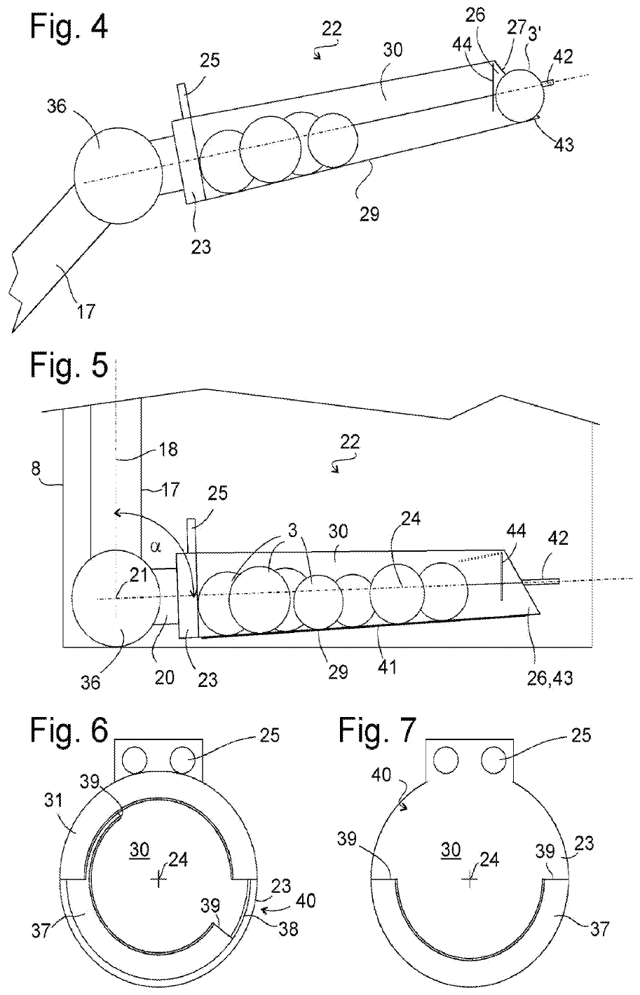

A distal portion 26 of the end effector 22 has an inlet opening 27 designed to be placed over the fruit 3′ chosen to be picked and means 28 for severing a stalk connecting the fruit 3 to the tree once the fruit 3 is soundly received in the inlet opening. Generally, these severing means 28 can be of any type known in the art. As an example, the severing means 28 may comprise fingers 42 (cf. FIG. 4) on both sides of the inlet opening 27 that are displaceable or inflatable so as to seize a fruit, so that its stalk can be severed by a receding movement of the end effector 22, and a spout 43 projecting below the fingers 42 and the fruit seized by them, in order to receive the fruit when it is released by the fingers 42, and to guide it into a storage bay formed in an intermediate portion 29 of the end effector 22.

When actually picking the fruit 3′, the end effector 22 is held with its longitudinal axis 24 inclined slightly downward from the distal portion 26 to the proximal portion 23, so that the fruit 3′, when detached from the tree and released by the severing means 28, will roll or slide from the inlet opening 27 to the storage bay of the intermediate portion 29.

The distance from the tips of fingers 42 to the distal joint 36 is slightly less than the length of box 8, i.e., 1.20 m, so that the end effector 22 can reach into the box with its longitudinal axis 24 parallel to a sidewall of the box.

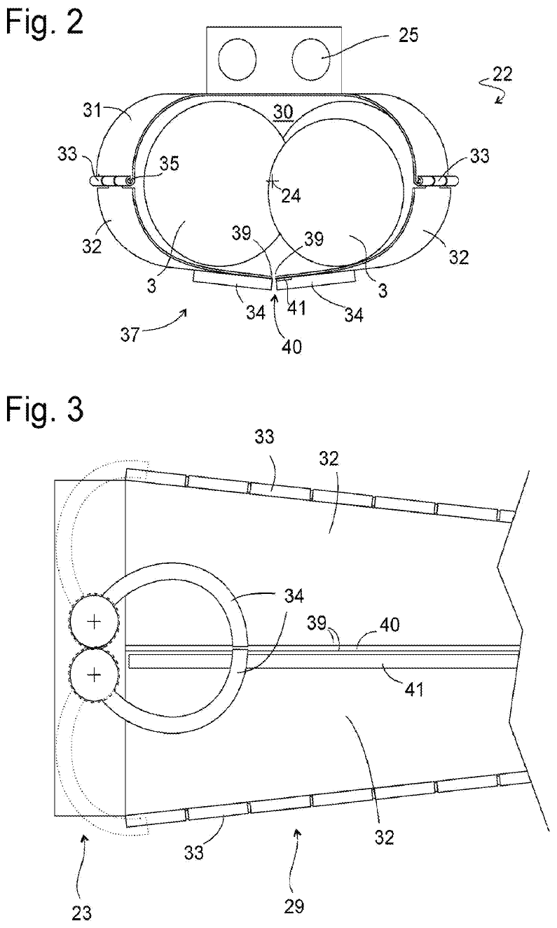

FIG. 2 is a cross section of the intermediate portion 29 of end effector 22 in a plane perpendicular to longitudinal axis 24. The storage bay 30 is delimited by an upper shell 31, and a support member 37 formed e.g. from plastic or sheet metal. The support member 37 comprises two flaps 32 connected to longitudinal edges of the upper shell 31 by hinges 33. The fruit finding sensor 25, e.g., a stereo camera capable of locating fruit in three dimensions, is mounted on top of the upper shell 31. The flaps 32, when locked in the position shown, form a concave surface where picked fruit 3 assumes a stable position and does not roll. Inclination of the end effector 22 along axis 24, as shown in FIG. 4, causes the fruit 3 to assume a staggered configuration, alternatingly displaced to the right and to the left from axis 24. At the proximal end, the storage bay 30 may be wide enough to allow the fruit to lie in two rows, side by side on either side of the axis 24. In contrast, inlet opening 27 is just wide enough to allow one fruit at a time to pass through.

FIG. 3 shows the proximal and intermediate portions 23, 29 of end effector 22 in a view from below. Latches 34 are rotatably mounted to the proximal portion 23. In picking operation, the latches 34 extend below the flaps 31 and lock these in the closed position of

FIG. 2, as shown in solid lines in FIG. 3. When the storage bay 30 is full and its content is to be discharged, the latches 34 are rotated into the unlocked position shown in phantom in FIG. 3 by an actuator provided in proximal portion 23, so that the flaps 31 will swing open under the weight of the fruit in the storage bay 30. A proximity sensor 41 extends along an edge of at least one of the flaps 32 opposite to its hinge 33.

The hinges 33 may be provided with a spring, e.g. a torsion spring 35, which urges the flaps 32 towards the closed position but is strong enough to hold them there only when they carry no fruit. Thus, the spring 35 can raise the flaps 31 again after all fruit has been discharged, and the latches 34 can be rotated back into the position shown in solid lines, thereby locking the flaps 31 in the closed position. Alternatively, when the latches 34 are being rotated back from the unlocked to the locked position, their tips will press against the flaps 32 and thus swing the flaps 32 back in into the closed position. As can be understood from FIG. 2, when the flaps 32 swing down, and a discharge port 40 between their facing edges widens, fruit 3 supported on the flaps 32 is gradually descended until the discharge port 40 finally becomes wide enough to let it pass. If the opening movement of the flaps 32 is controlled appropriately, the fruit 3 may already be supported by a surface below, i.e. by the bottom of box 8 or by fruit in the box 8, before the discharge port 40 actually gets wide enough to let the picked fruit 3 pass. Thus, dropping the fruit 3 in the discharge process can be avoided completely.

FIG. 4 shows the end effector 22 in the process of picking fruit.

Between the distal portion 26 and the storage bay 30, a valve flap 44 can be provided. The valve flap 44 swings by an axis close to its upper edge, and from a position in which it blocks the passage from the distal portion 26 to the storage bay 30, as shown in FIG. 4,. it is displaceable towards the storage bay 30 only, so that while the end effector is inclined downwardly, a picked fruit 3′ can displace the flap 44 and reach the storage bay, but if the end effector must assume an upwardly inclined pose, fruit in the storage bay 30 can press the flap 44, but not open it.

While inclination of the intermediate link 17 may vary widely depending on the height above ground of a fruit 3′ being picked, the inclination of the end effector is controlled to vary as little as possible, so that fruit 3 in the storage bay 30 won't move while more fruit is added.

The maximum inclination under which picking of fruit is enabled may vary depending on the variety of fruit. For apples, it may be higher than for soft fruit such as e.g. kiwi. It may also vary depending on how full the storage bay 30 is: the fuller it is, the shorter is the path the fruit can travel from the distal portion 26 before it comes to rest in the storage bay; so a steeper inclination can be allowed the fuller the storage bay 30 is. The controller may be programmed to count the number of fruit picked, and to judge, based on this count, whether the storage bay 30 is full and should be discharged or not. Alternatively, the controller may estimate the weight of the fruit in storage bay 30 based on the torques acting on motor 19 and the motor that controls rotation of the end effector 22 by axis 24. When this weight exceeds a predetermined threshold, the storage bay 30 is judged to be full, and the fruit in it must be discharged. To this effect, the end effector 22 must be moved into the pallet box 8. The length of the proximal link 13 is such that when it is inclined towards the pallet box 8, the intermediate motor member 14 can be placed above an upper edge of the box 8 so that the distal link 17, by extending vertically downward, reaches into the box 8 and can place the end effector 22 near its bottom. Preferably, the end effector 22 maintains its inclination in the process, in order to prevent the fruit from rolling, so that when the end effector 22 is at the bottom of the box, the axes 18, 24 of the distal link 17 and of the end effector 22 form an acute angle a. To make sure the end effector can always reach the bottom of the box, the length of the distal link 17 should be just equal to or slightly greater than the height of box 8.

Proximity sensor 40 detects whether the distance of the end effector 22 to the bottom of the box 8 or to fruit already present in pallet box 8 is below a predetermined threshold; only in that case, the controller will enable unlocking the flaps 32.

The proximity sensor can provide a quantitative measure of the distance to the fruit in pallet box 8, or it can provide a binary output which merely indicates whether the distance is below a threshold or not. The latter type of sensor is cheaper, but it has the disadvantage that inside the box 8 the advancing speed of the end effector 22 must be limited to a safe speed which is so low that, when it is detected that the distance has dropped below the threshold, the end effector 22 can safely be bought to a halt before it bumps into the fruit. The controller may record the level of fruit in the box 8 thus detected; when the storage bay 30 has to be discharged the next time, the controller can have the end effector 22 enter the box 8 at a speed considerably higher than said safe speed, and reduce it to said safe speed only in the vicinity of said recorded level. Thus the duration of the discharge process can be shortened considerably.

Before actually discharging the fruit, the end effector 22 can be turned by axis 21 into an orientation where its bottom side is substantially horizontal, so that even close to the distal end of the storage bay 30, fruit will not fall out when the storage bay 30 when opened, but will be lowered smoothly and gradually.

By rotating the latches 34 towards their unlocked position, the flaps 13 gradually swing downward, and the fruit gradually slide towards the outlet port which is opening between the flaps 31, and will come to rest on the bottom of the box 8 or on other fruit already present in the box before the port becomes wide enough for the fruit to pass. FIG. 6 is a cross section, perpendicular to longitudinal axis 24, of an end effector according to a second embodiment of the invention. The storage bay 30 is cylindrical or conical, comprising a support member 37 which is slidably received in a circular rail 38 of proximal portion 23, so as to be rotatable around longitudinal axis 24. In a closed position, longitudinal edges 39 of support member 37 are at equal height and overlap with edges of upper shell 31 . In FIG. 6, the support member 37 is rotated clockwise out of said closed position, so that a discharge port 40 is starting to open between the support member 37 and the upper shell 31. In the embodiment of FIG. 7, the support member 37 is fixed to the proximal portion 23 of the end effector, and the end effector 22 is fixed to adapter 20, so that the above-mentioned sixth motor rotates not only adapter 20 but also the complete end effector 22 by the latter's longitudinal axis 24. In the process, fruit will roll or slide on support member 27 until they pass one of its longitudinal edges 39 and are thus discharged from storage bay 30.

The support member may be pivotable about a longitudinally extending axis to enable discharging the fruit by the discharge port. The support member may be free to pivot with respect to the proximal portion of the end effector, or both the proximal portion and the support member may be pivoted by the end effector being mounted to an adapter of a robot arm and the adapter being rotated by the longitudinal axis. While the picking tools may be specific to the fruit to be picked, the storage bay hardly needs such adaptation except perhaps in its size. So the end effector of the present invention can be applied to picking apples pears, stone fruits, citrus fruits and berries, tomatoes, cucumbers, peppers, egg-plant, squash, zucchini, artichokes etc.

When a fruit has been picked by the distal portion and is transferred to the storage bay of the intermediate portion, the distal portion is free to pick another fruit without having to dispose of the other first. Thus, several fruit hanging on a same branch of a plant can be picked one after the other in quick succession, without the end effector having to be removed from the plant in the process, until the storage bay is full.

The longitudinal dimension of the intermediate portion can be a multiple of the transversal dimension of the distal portion. The transversal dimension of the distal portion will be wide enough to accommodate a fruit to be picked; when the longitudinal dimension of the intermediate portion is a multiple thereof, several fruit will fit in it in a longitudinal row (or a staggered configuration) before the storage bay is full and has to be discharged.

When the storage bay is sized to accommodate the fruit in a single row or a staggered configuration, they can effectively be prevented from rolling around in the storage bay before being discharged, and the risk the fruit being damaged in the storage bay is minimized.

Where the storage bay has distal and proximal ends, an inlet port by which the storage bay receives picked fruit from the distal portion will be formed at said distal end. The proximal end of the storage bay should be wider than the distal end, so that when the storage bay is being filled with fruit, a large number of these can gather close to the proximal end, thus minimizing the torque to which is subject a distal joint of a robot arm that carries the end effector. The support member may be in the shape of a gutter extending in the longitudinal direction. Thus, fruit can be ejected by rotating the support member around the longitudinal axis, thereby turning downward the open side of the gutter. When the support member is cylindrical with the longitudinal axis at its center, it can be placed on a surface, and by rotating it around the longitudinal axis, the fruit can be caused to roll off the support member and onto the surface smoothly, without any abrupt drop.

In another embodiment, the support member may comprise two flaps having swing axes extending in the longitudinal direction, the discharge point being defined between longitudinally extending edges of the two flaps facing each other. Here, too, the flaps might be cylindrical with the swing axes at the center of the respective cylinders, so as to avoid any change in height of the fruit in the discharge process. Alternatively, here, the flaps may have an arbitrary shape, and fruit may be discharged by being lowered gently while the discharge port gradually opens between facing edges of the two flaps gradually moving away from each other.

The support member can be spring-biased towards its closed position.

When the support member comprises flaps as mentioned above, the strength of the spring should be sufficient to urge the flaps into their closed position when they support no fruit, but low enough for one fruit resting on one of the flaps to urge it open. Thus the flaps won't close while there is fruit left in the storage bay, but will close again once the storage bay is empty.

The end effector should further comprise a latch for locking the flap in the closed position, so that it won't open and drop fruit in the picking process, and an actuator for displacing the latch when the storage bay is to be discharged. The actuator can be a mechanical switch, to be operated by contact with the bottom of a collecting box or with other fruit already present in the collecting box. Such a mechanical switch can ensure that the flap will not open unless the distance by which the fruit will be descended is certain not to cause damage to them. Alternatively, the actuator can be operated by a remote controller, so as to prevent an accidental opening of the port due to e.g. contact with a branch. A fruit finding sensor, e.g., a camera, may be provided in the distal portion of the end effector. By thus being spaced from a fruit to be picked by the storage bay, a potentially harmful physical contact of the sensor with the plant carrying the fruit can be avoided; further, when a fruit has been located using the sensor and is in the process of being picked, the sensor can already be used for locating other fruit to be picked in the vicinity.

The end effector may further comprise a sensor for sensing a distance between the support member and a surface underneath. Thus, discharge of fruit from the storage compartment can be disabled except when the sensor detects that the distance to a surface onto which the fruit will be discharged is small enough to prevent damage to the fruit.

According to a second aspect of the invention, the object is achieved by a fruit-picking robot comprising the end effector as described above and an articulated arm carrying the end effector.

Where a distal link of the articulated arm is connected to the end effector by a distal joint, the joint should be operable to form a right angle or an acute angle between the longitudinal axis of the end effector and a longitudinal axis of the distal link. In this way, the end effector and a distal portion of the arm can enter a collecting box from above and place the end effector in immediate vicinity of a horizontal bottom of the box, so that the fruit can be discharged gently, without dropping them. In order to make sure that the end effector can reach the bottom of the box, the length of the distal link should be not less than the height of the box. The height of the box may vary, depending on the type of fruit picked. Where the box is a standard box of EUR1 or EUR2 type, its height can be 60 or 80 cm; so the length of the distal link should be greater than at least 60, preferably 80 cm.

The distance between the distal joint of the robot arm and the distal portion of the end effector should be slightly less than one of the two horizontal dimensions of the box. In that way, for discharging the fruit, the end effector can be placed in the box parallel to one wall of the box and extending over nearly the entire length of that wall. By placing the end effector at different distances from the wall in successive discharging procedures, the fruit can be discharged in rows, thereby preventing formation of a cone. On the one hand, this ensures that space in the box is used efficiently, on the other, there is no risk of fruit being damaged when rolling down the slope of the cone.

A controller of the robot may be adapted to carry out a picking operation only while the longitudinal axis is inclined downwardly from the distal portion to the proximal portion, so that once detached from the plant, a fruit will not fall out of the distal portion but will be propelled towards the storage compartment by its own weight. The controller may further be adapted to carry out the picking operation only if inclination of the longitudinal axis is below a first predetermined threshold, so that the fruit will advance slowly into the storage compartment without being damaged or causing damage to fruit already present. After having picked a fruit and before discharging it, the downward inclination of the end effector should be maintained in order to prevent fruit from rolling to and fro in the storage bay or even falling out by the distal portion. Inclination may be maintained below a second predetermined threshold at that time, in order to prevent the fruit in the storage bay from changing positions before being discharged to the collecting box. A weight sensor or torque sensor that may be present in the distal joint of the articulated arm can be used by the controller for estimating the amount of fruit picked and, based thereon, for deciding whether the storage bay is so full that it should be discharged before picking more fruit. Alternatively or additionally, the controller may be adapted to count the number of fruits picked (or rather, the number of picking operations of the end effector, and to discharge the storage bay whenever a given maximum number has been reached.

An adapter of the articulated arm should be rotatable by the longitudinal axis. Such a rotation may be necessary in order to maintain the orientation of the end effector and to prevent fruit in it from rolling around throughout the picking process, until the storage bay is to be discharged. Discharging can then be done by rotating the adapter, and, along with it, while the rest of the articulated arm is held still.

The robot may further comprise a cart which has the articulated arm mounted to it, the cart optionally having a support for a fruit collecting box which the end effector is adapted to enter for discharging fruit. The cart can be a trailer to be drawn by a tractor or the like, preferably it is an AGV (autonomous guided vehicle), capable of navigating by itself e.g. between trees of an orchard.

Further features and advantages of the invention will become apparent from the subsequent description of embodiments, referring to the appended drawings.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Reference Numerals

1 robot
2 tree
3 fruit
4 cart 5 basis
6 arm
7 support
8 pallet box
9 channel 10 proximal motor member
11 motor
12 motor
13 proximal link
14 intermediate motor member 15 7-8 motor
16 Motor
17 distal link
18 axis
19 motor
20 adapter
21 axis
22 end effector
23 proximal portion
24 longitudinal axis 25 fruit finding sensor
26 distal portion
27 inlet opening 28 severing means
29 intermediate portion
30 storage bay
31 upper shell 32 flap
33 hinge
34 latch
35 spring
36 joint 37 support member
38 rail
39 longitudinal edge
40 discharge port
41 proximity sensor 42 finger
43 spout
44 valve flap

What is claimed is:

1. An end effector for a fruit picking robot, comprising:
a distal portion comprising tools for seizing and adapted for detaching a fruit from a mother plant;
a proximal portion comprising an interface for mounting the end effector to a robot arm; and
a storage bay for picked fruit, the storage bay being elongate in a longitudinal direction;
wherein the storage bay includes a discharge port extending along a full length of the storage bay in the longitudinal direction; and
a fruit support member having a longitudinally extending edge that delimits the discharge port.

2. The end effector of claim 1, wherein the support member is pivotably disposed relative to a longitudinally extending axis and configured to enable discharging fruit through the discharge port.

3. The end effector of claim 1, wherein the storage bay is disposed in an intermediate portion of the end effector between the distal and proximal portions.

4. The end effector of claim 1, wherein the support member is shaped as a gutter extending in the longitudinal direction.

5. The end effector of claim 1, wherein the support member comprises two flaps having swing axes extending in the longitudinal direction, wherein the discharge port is defined between longitudinally extending edges of the two flaps that face one another.

6. The end effector of claim 5, further comprising a latch configured for locking the support member in a closed position, and an actuator configured for displacing the latch.

7. The end effector of claim 1, further comprising a fruit finding sensor disposed on the distal portion of the end effector.

8. The end effector of claim 1, further comprising a sensor for sensing a distance between the fruit support member and a surface adjacent to it.

9. A fruit-picking robot, comprising:
an articulated arm, and
an end effector disposed on the articulated arm, the end effector comprising:
a distal portion comprising tools for seizing and adapted for detaching a fruit from a mother plant;
a proximal portion comprising an interface for mounting the end effector to the articulated arm; and
a storage bay for picked fruit, the storage bay being elongate in a longitudinal direction;
wherein the storage bay includes a discharge port extending along a full length of the storage bay in the longitudinal direction; and
a fruit support member having a longitudinally extending edge that delimits the discharge port.

10. The fruit-picking robot of claim 9, wherein the support member is pivotably disposed relative to a longitudinally extending axis and configured to enable discharging fruit through the discharge port.

11. The fruit-picking robot of claim 9, wherein the storage bay is disposed in an intermediate portion of the end effector between the distal and proximal portions.

12. The fruit-picking robot of claim 9, wherein the support member is shaped as a gutter extending in the longitudinal direction.

13. The fruit-picking robot of claim 9, wherein the support member comprises two flaps having swing axes extending in the longitudinal direction, wherein the discharge port is defined between longitudinally extending edges of the two flaps that face one another.

14. The fruit-picking robot of claim 13, further comprising a latch configured for locking the support member in a closed position, and an actuator configured for displacing the latch.

15. The fruit-picking robot of claim 9, further comprising a fruit finding sensor disposed on the distal portion of the end effector.

16. The fruit-picking robot of claim 9, further comprising a sensor for sensing a distance between the fruit support member and a surface adjacent to it.

17. The fruit-picking robot of claim 9, wherein a distal link of the articulated arm is connected to the end effector by a distal joint, and wherein the distal joint is operable to form a right angle or an acute angle between the longitudinal axis of the end effector and a longitudinal axis of the distal link.

18. The fruit-picking robot of claim 9, further comprising a controller adapted to carry out a picking operation while the longitudinal axis is inclined downwardly from the distal portion towards the proximal portion.

19. The fruit-picking robot of claim 18, wherein the controller is adapted to carry out the picking operation when inclination of the longitudinal axis is below a first predetermined threshold.

20. The fruit-picking robot of claim 19, wherein the controller is adapted to maintain the longitudinal axis downwardly inclined and below a second predetermined threshold after having picked a fruit and before discharging it.

21. The fruit-picking robot of claim 9, further comprising a weight sensor or torque sensor for sensing weight or torque of the end effector, the controller being adapted to discharge the fruit when output of the sensor exceeds a predetermined threshold.

22. The fruit-picking robot of claim 9, wherein an adapter of the articulated arm is rotatable about the longitudinal axis between a position in which the discharge port is facing up and a position in which the discharge port is facing down.

23. The fruit-picking robot of claim 9, further comprising a cart having the articulated arm mounted thereon, the cart having a support for a fruit collecting box into which the end effector is adapted to enter for discharging fruit.
